(19) United States
(12) Patent Application Publication
(10) Pub. No.: US 2002/0199017 A1
(43) Pub. Date: Dec. 26, 2002

(54) Routing meta data for network file access

(76) Inventor: Lance W. Russell, Hollister, CA (US)

Correspondence Address: HEWLETT-PACKARD COMPANY, Intellectual Property Administration, P.O. Box 272400, Fort Collins, CO, 80527-2400, US

(21) Appl. No.: 09/888,544

(22) Filed: Jun. 25, 2001

(51) Int. Cl. G06F 15/16; G06F 15/173

(52) U.S. Cl. 709/243; 709/238; 709/219

(57) ABSTRACT

Systems and methods by which data files may be accessed over routable networks are described. In accordance with this approach, routing meta data is provided along with conventional file access meta data in response to a data file access request so that client file systems may optimize the selection of routes over which a file is accessed based upon client-specific criteria (e.g., packet delay and fragmentation criteria). In this way, the sub-optimal route selection that may occur with table-based network routing protocols, as well as the network overhead that otherwise would be required to select optimal routes using such table-based network routing protocols, are avoided.

### TECHNICAL FIELD

This invention relates to systems and methods for accessing data files in a distributed computing environment.

### BACKGROUND

In modern computer systems, large collections of data usually are organized as data files (or simply “files”) on physical disk storage systems, which may be distributed over multiple computer systems. Client programs may access the data files by requesting file services from one or more file systems. In addition to providing access to data files, file systems may perform administrative functions, such as controlling coherent access by the clients, communicating with physical storage components, maintaining redundant file copies, and recovering from failure. In most file systems, data files include user data and meta data. The meta data typically includes information needed to manage the user data, such as file names, locations, dates, file sizes, and access protection.

Computers may communicate with each other and with other computing equipment over various types of data networks. Routable data networks are configured to route data packets (or frames) from a source network node to one or more destination network nodes. As used herein, the term “routable protocol” refers to a communications protocol that contains a network address as well as a device address, allowing data to be routed from one network to another. Examples of routable protocols are SNA, OSI, TCP/IP, XNS, IPX, AppleTalk, and DECnet. A “routable network” is a network in which communications are conducted in accordance with a routable protocol. One example of a routable network is the Internet, in which data packets are routed in accordance with the Internet Protocol (IP). In a routable data network, when a network routing device (or router) receives a data packet, the device examines the data packet in order to determine how the data packet should be forwarded. Similar forwarding decisions are made as necessary at one or more intermediate routing devices until the data packet reaches a desired destination node.

Network routers typically maintain routing tables that specify network node addresses for routing data packets from a source network node to a destination network node. When a data packet arrives at a router, an address contained within the packet is used to retrieve an entry from the routing table that indicates the next hop (or next node) along a desired route to the destination node. The router then forwards the data packet to the indicated next hop node. The process is repeated at successive router nodes until the packet arrives at the desired destination node. A data packet may take any available path to the destination network node. In accordance with IP, data packets are routed based upon a destination address contained in the data packet. The data packet may contain the address of the source of the data packet, but usually does not contain the address of the devices in the path from the source to the destination. These addresses typically are determined by each routing device in the path based upon the destination address and the available paths listed in the routing tables.

In operation, a routing device applies a routing algorithm to the entries of a routing table to obtain the physical address of the next hop node. In accordance with IP, packet routing typically involves a three-step process. First, the routing device determines from the destination IP address of a data packet whether the address appears among the direct routes specified in the routing table; in which case, the data packet is sent to the directly attached network device. If the destination address does not correspond to a direct route, the routing device determines if an indirect route for the destination address is specified in the routing table; in which case, the data packet is forwarded to the specified gateway IP address. Finally, if no direct or indirect route is specified in the routing table, the data packet may be sent to a default address or, if no default address is specified, an error data packet is returned to the source network node.

The routing tables that are used by routing devices in IP networks may be constructed in a number of different ways. For example, a device that maintains a routing table of all possible network routes may broadcast a routing table to each routing device in the network. Alternatively, each routing device may build and maintain its own routing table based upon communications with other network devices. In some routing schemes, a fixed or static routing table may be used by a routing device for each data packet to be routed.

### SUMMARY

The invention features a novel scheme (systems and methods) by which data files may be accessed over routable networks. In accordance with this inventive scheme, routing meta data is provided along with conventional file access meta data in response to a data file access request so that client file systems may optimize the selection of routes over which a file is accessed based upon client-specific criteria (e.g., packet delay and fragmentation criteria). In this way, the invention avoids sub-optimal route selection that may occur with table-based network routing protocols. In addition, the invention avoids the network overhead that otherwise would be required to select optimal routes using such table-based network routing protocols.

In one aspect, the invention features a method of accessing a data file in a distributed computing environment. In accordance with this inventive method, physical address meta data and routing meta data for one or more logical file blocks of a data file are sent from a source site to a client site in response to a request from the client site for access to the data file.

Embodiments in accordance with this aspect of the invention may include one or more of the following features.

A data structure comprising physical address meta data and routing meta data for one or more logical file blocks of the requested data file preferably is stored at the source site.

The routing meta data preferably comprises one or more node addresses along one or more network routes between the client site and the source site for the one or more logical file blocks of the requested data file. In some embodiments, the routing meta data comprises next hop node addresses from the client site for each of the one or more network routes. In other embodiments, the routing meta data comprises complete path information from the client site to the source site for each of the one or more network routes.

The meta data preferably is sent to the client site in accordance with a routable network protocol.

In another aspect of the invention, one of two or more network routes over which a logical file block of the data file is accessible is selected at a client site based upon routing meta data incorporated within a data structure containing file access meta data including physical address meta data.

Embodiments in accordance with this aspect of the invention may include one or more of the following features.

A network route over which to access the logical file block preferably is selected at the client site based upon information relating to one or more transmission characteristics of each of the two or more network routes. For example, a network route may be selected based upon load characteristics of the two or more network routes or physical media characteristics of the two or more network routes.

The logical file block preferably is accessed over the selected network route in accordance with a routable network protocol.

In another aspect, the invention features a source site file system that is configured to manage access to one or more logical file blocks of a data file and to send to a client site physical address meta data and routing meta data for the one or more logical file blocks in response to a request from the client site for access to the data file.

In another aspect, the invention features a client site file system that is configured to select one of two or more network routes over which a logical file block of the data file is accessible based upon routing meta data incorporated within a data structure containing file access meta data including physical address meta data.

In another aspect, the invention features a data structure for accessing a data file in a distributed computing environment. The data structure comprises physical address meta data and routing meta data for one or more logical file blocks of the data file.

The routing meta data preferably comprises one or more node addresses along one or more network routes between a requesting client site and a source site for the one or more logical file blocks of the data file.

Other features and advantages of the invention will become apparent from the following description, including the drawings and the claims.

### DESCRIPTION OF DRAWINGS

FIG. 1 is a block diagram of a client site with network connections to a source site through two different networks.

FIG. 2 is a flow diagram of a method by which a client application program operating at the client site of FIG. 1 may access a file stored at the source site of FIG. 1.

FIG. 3 is a flow diagram of a method by which a file server operating at the source site of FIG. 1 may handle file access requests received from the client site of FIG. 1.

FIG. 4 is a table for a data structure containing file access meta data, including physical address meta data and routing meta data.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

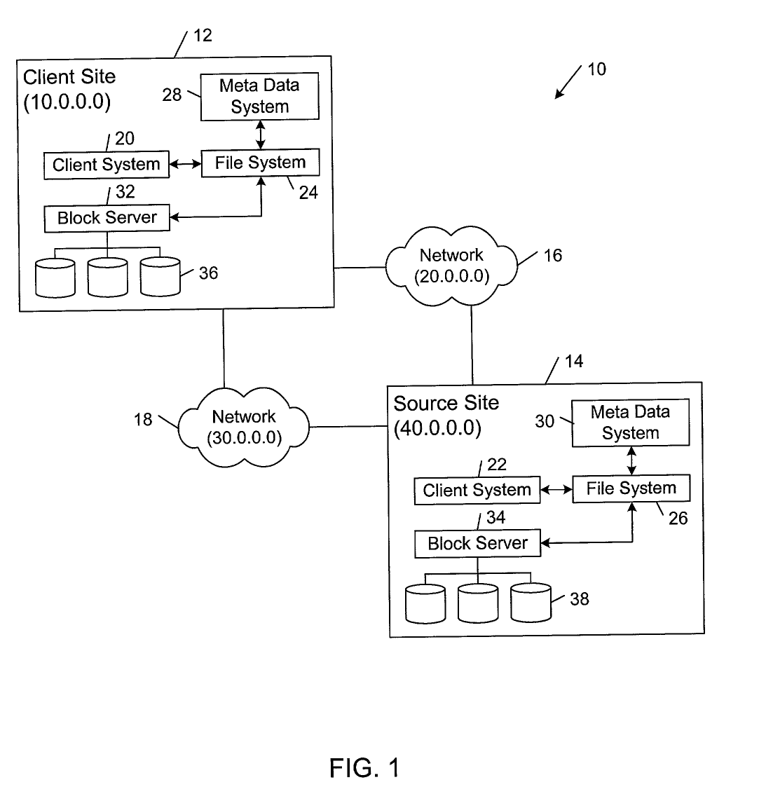

Referring to FIG. 1, in one embodiment, a distributed computing system 10 includes a client site 12 that is connected to a source site 14 through two intermediate networks 16, 18. Client site 12 and source site 14 each respectively includes a client system 20, 22, a file system 24, 26, a meta data system 28, 30, a block server 32, 34, and one or more physical storage systems 36, 38. Client site 12 and source site 14 each may be implemented as a single computer system or multiple computer systems that are interconnected to form a network (e.g., a local area network (LAN) or a wide area network (WAN)). In multi-computer system embodiments, the component systems 20-38 of client site 12 or source site 14, or both, may be implemented in one or more separate computer systems. Client site 12 and source site 14 also include conventional network interfaces (not shown) that provide electronic and communication interfaces to intermediate networks 16, 18.

Intermediate networks 16, 18 each may be implemented as a LAN or a WAN. Intermediate networks 16, 18 may be connected to client site 12 and source site 14 by conventional network routers (not shown). Intermediate networks 16, 18 may be of the same or different types. For example, intermediate network 16 may be an Ethernet network and intermediate network 18 may be an ATM (Asynchronous Transfer Mode) network. In addition, intermediate networks 16, 18 may have different performance characteristics from one another. For example, intermediate networks 16, 18 may have different load conditions, transmission characteristics, and maximum transmission unit (MTU) sizes (i.e., the largest packet sizes that can be transmitted over the networks).

Communications over distributed computing system 10 are conducted in accordance with a routable communications protocol (e.g., TCP/IP, SNA, OSI, XNS, IPX, AppleTalk, and DECnet). In the illustrated embodiment, network communications over distributed computing system 10 are described in accordance with the TCP/IP protocol. Accordingly, client site 12, source site 14, and intermediate networks 16, 18 each are assigned a unique 32-bit IP address. For example, in the illustrated embodiment, client site 12 is assigned an IP address 10.0.0.0, source site 14 is assigned an IP address 40.0.0.0, and intermediate networks 16, 18 are assigned IP addresses 20.0.0.0 and 30.0.0.0, respectively. Any additional network nodes (e.g., routers) that are distributed along the routes between client site 12 and source site 14 also would be assigned a respective IP address.

In one implementation, the physical storage systems 38 of source site 14 contain one or more client data files. The logical file blocks of each of the data files may be distributed (e.g., striped) across the disks of an individual disk array within one or more of the physical storage systems 38. As explained in detail below, an application program operating at client site 12 may access the logical file blocks of the data files stored at source site 14 in accordance with an efficient routable communications protocol. In this approach, source site 14 provides to client site 12 routing meta data along with conventional file access meta data in response to a data file access request so client file system 24 may optimize the selection of routes over which a data file is accessed based upon client-specific criteria (e.g., packet delay and fragmentation criteria). In this way, the sub-optimal route selection that may occur with table-based network routing protocols in which routing decisions are made based upon network traffic considerations, rather than file system considerations, are avoided. In addition, the network overhead that otherwise would be required to select optimal routes using such table-based network routing protocols (e.g., file system access to routing tables in addition to normal network traffic access), are avoided.

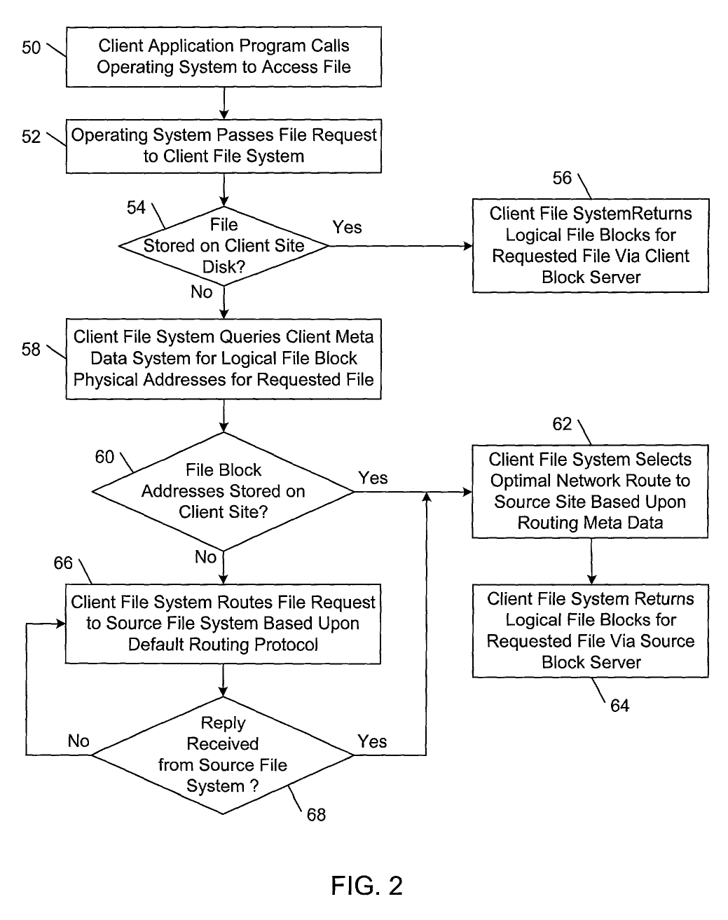

Referring to FIG. 2, in one embodiment, a client application program operating at client site 12 may access a data file stored at source site 14, as follows. The client application program initiates a data file access request through a call to the local operating system (step 50). The operating system passes the file request to the client file system 24 (step 52). If the data file is stored locally on a disk of physical storage systems 36 (step 54), the client file system 24 accesses the data file through client block server 32 and returns the logical file blocks of the requested data file to the client application program (step 56).

In some embodiments, the client meta data system 28 may store the physical addresses of the logical file blocks for previously requested data files that are accessed from remote sources. Accordingly, if the requested data file is not stored at the client site 12 (step 54), the client file system 24 may query the client meta data system 28 to determine whether the physical addresses of the logical file blocks for the remotely-stored data file are available at the client site 12 (step 58). If the logical file block addresses for the requested file are stored at the client site 12 (step 60), the client file system 24 selects an optimal network route to source site 14 based upon routing meta data associated with the physical address information for the requested data file (step 62). For example, client file system 24 may select a network route to source site 14 based upon packet delay and fragmentation criteria. In this case, client file system 24 would consider, for example, the load conditions, transmission characteristics, and MTU sizes of intermediate networks 16, 18. Again, these considerations generally will be different for the file system vis-à-vis general network traffic. Therefore, even if the file system uses the same routing algorithms as the general networking code to determine optimal routes, the file system may select a different path than the general network code. This information may be collected by client file system 24 in accordance with a conventional network protocol. After selecting an optimal network route over which to access the requested data file (step 62), client file server 24 accesses the logical file blocks for the requested data file through source block server 34 and returns the logical file blocks to the client application program (step 64).

If the logical file block addresses for the requested file are not stored at the client site 12 (step 60), the client file system 24 routes the data file request to the source file system 26 based upon a conventional routing protocol (e.g., a table-based routing protocol) (step 66). The client file system 24 may be configured to periodically transmit the data file request to the source file system 26 until a reply is received (step 68). After meta data for the requested data file, including physical address meta data and routing meta data, is received from source file system 26, the client file system 24 selects an optimal network route to source site 14 based upon the associated routing meta data (step 62). Next, client file system 24 accesses the logical file blocks for the requested data file through source block server 34 and returns the logical file blocks to the client application program (step 64)

In some embodiments, client file system 24 may be configured to select a single route over which to access all of the logical file blocks of the data file requested by the client application program. In other embodiments, client file system 24 may be configured to select access routes on a block-by-block basis, depending on, for example, current network conditions, including route availability, or current file access criteria, such as delay and packet fragmentation requirements.

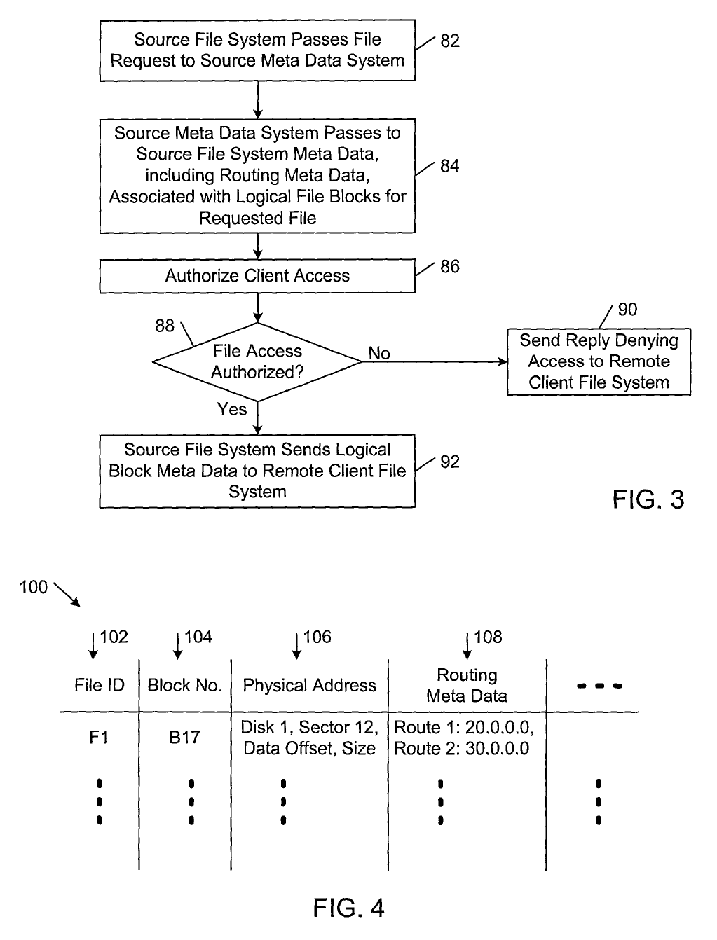

Referring to FIG. 3, in one embodiment, source file system 26 may be configured to handle file access requests from client site 12, as follows. After a data file access request is received from client file system 24, the source file system passes the data file request to the source meta data system 30 (step 82). The source meta data system 30 returns to the source file system 26 meta data that is associated with the requested data file, including access protection meta data, physical address meta data for the logical file blocks of the requested data file, and routing meta data (84). Next, the source file server 26 authorizes the client access based upon the access protection meta data received from source meta data system 30 (step 86). If the client is not authorized to access the requested data file (step 88), the source file system 26 sends to client file system 24 a reply denying access to the requested file (step 90). If the client is authorized to access the requested data file (step 88), source file server 26 sends to the client file system 24 a reply containing meta data associated with the logical file blocks for the requested data file, including the physical address meta data and the routing meta data.

As shown in FIG. 4, in one embodiment, the meta data associated with the logic file blocks of a data file may be stored by source meta data system 30 as a table-based data structure 100. Data structure 100 includes a table row for each logical file block of a data file. The data files may be identified by file identifiers 102 (File ID) and the logical file blocks may be identified by block numbers 104 (Block No.). The physical addresses 106 of the logical file blocks may be specified by disk number, sector number, as well as data offset and data size information. The routing meta data 108 contains information relating to the network routes connecting client site 12 and source site 14. In some embodiments, the routing meta data 108 may contain addresses for each node along each of the network routing paths between client site 12 and source site 14. In other embodiments, the routing meta data 108 may contain incomplete routing information (e.g., only next hop node addresses from the client site 12 for each of the possible network routes). The granularity of the routing meta data may be at the block level as shown or, in other embodiments, it may be at a higher level (e.g., at the disk level). The routing meta data may be collected by the source meta data system in accordance with a conventional routing table construction protocol.

The systems and methods described herein are not limited to any particular hardware or software configuration, but rather they may be implemented in any computing or processing environment, including in digital electronic circuitry or in computer hardware, firmware or software. The component systems of the client site 12 and the source site 14 may be implemented, in part, in a computer program product tangibly embodied in a machine-readable storage device for execution by a computer processor. In some embodiments, these systems preferably are implemented in a high level procedural or object oriented programming language; however, the algorithms may be implemented in assembly or machine language, if desired. In any case, the programming language may be a compiled or interpreted language. The methods described herein may be performed by a computer processor executing instructions organized, for example, into program modules to carry out these methods by operating on input data and generating output. Suitable processors include, for example, both general and special purpose microprocessors. Generally, a processor receives instructions and data from a read-only memory and/or a random access memory. Storage devices suitable for tangibly embodying computer program instructions include all forms of non-volatile memory, including, for example, semiconductor memory devices, such as EPROM, EEPROM, and flash memory devices; magnetic disks such as internal hard disks and removable disks; magneto-optical disks; and CD-ROM. Any of the foregoing technologies may be supplemented by or incorporated in specially-designed ASICs (application-specific integrated circuits).

Other embodiments are within the scope of the claims.

What is claimed is:

1. A method of accessing a data file in a distributed computing environment, comprising:
from a source site, sending to a client site physical address meta data and routing meta data for one or more logical file blocks of a data file in response to a request from the client site for access to the data file.

2. The method of claim 1, further comprising storing at the source site a data structure comprising physical address meta data and routing meta data for one or more logical file blocks of the requested data file.

3. The method of claim 1, wherein the routing meta data comprises one or more node addresses along one or more network routes between the client site and the source site for the one or more logical file blocks of the requested data file.

4. The method of claim 3, wherein the routing meta data comprises next hop node addresses from the client site for each of the one or more network routes.

5. The method of claim 3, wherein the routing meta data comprises complete path information from the client site to the source site for each of the one or more network routes.

6. The method of claim 1, wherein the meta data is sent to the client site in accordance with a routable network protocol.

7. A method of accessing a data file in a distributed computing environment, comprising:
at a client site, selecting one of two or more network routes over which a logical file block of the data file is accessible based upon routing meta data incorporated within a data structure containing file access meta data including physical address meta data.

8. The method of claim 7, further comprising:
at the client site, selecting a network route over which to access the logical file block based upon information relating to one or more transmission characteristics of each of the two or more network routes.

9. The method of claim 8, wherein a network route is selected based upon load characteristics of the two or more network routes.

10. The method of claim 8, wherein a network route is selected based upon physical media characteristics of the two or more network routes.

11. The method of claim 7, further comprising accessing the logical file block over the selected network route in accordance with a routable network protocol.

12. A system for accessing a data file in a distributed computing environment, comprising:
a source site file system configured to manage access to one or more logical file blocks of a data file and to send to a client site physical address meta data and routing meta data for the one or more logical file blocks in response to a request from the client site for access to the data file.

13. The system of claim 12, wherein the source site file system is configured to store a data structure comprising physical address meta data and routing meta data for one or more logical file blocks of the requested data file.

14. The system of claim 12, wherein the routing meta data comprises one or more node addresses along one or more network routes between the client site and the source site for the one or more logical file blocks of the requested data file.

15. A system for accessing a data file in a distributed computing environment, comprising:
a client site file system configured to select one of two or more network routes over which a logical file block of the data file is accessible based upon routing meta data incorporated within a data structure containing file access meta data including physical address meta data.

16. The system of claim 15, wherein the client site file system is configured to select a network route based upon information relating to one or more transmission characteristics of each of the two or more network routes:

17. The system of claim 16, wherein the client site file system is configured to select a network route based upon load characteristics of the two or more network routes.

18. The system of claim 16, wherein the client site file system is configured to select a network route based upon physical media characteristics of the two or more network routes.

19. A data structure for accessing a data file in a distributed computing environment, comprising:
physical address meta data and routing meta data for one or more logical file blocks of the data file.

20. The data structure of claim 19, wherein the routing meta data comprises one or more node addresses along one or more network routes between a requesting client site and a source site for the one or more logical file blocks of the data file.
